(19) United States
(12) Patent Application Publication
(10) Pub. No.: US 2025/0324300 A1
(43) Pub. Date: Oct. 16, 2025

(54) SIGNAL PROCESSING METHOD AND APPARATUS, AND DEVICE

(71) Applicant: VIVO MOBILE COMMUNICATION CO., LTD., Dongguan (CN)

(72) Inventor: Li CHEN, Dongguan (CN)

(21) Appl. No.: 19/250,112

(22) Filed: Jun. 26, 2025

Related U.S. Application Data
(63) Continuation of application No. PCT/CN2023/140473, filed on Dec. 21, 2023.

(30) Foreign Application Priority Data
Dec. 28, 2022 (CN) 202211701768.2

(51) Int. Cl. H04W 24/08; H04W 24/10; H04W 64/00; H04W 84/04

(52) U.S. Cl. CPC H04W 24/08; H04W 24/10; H04W 64/00; H04W 84/042

(57) ABSTRACT

This application pertains to the field of communication technologies, and discloses a signal processing method and apparatus, and a terminal. The signal processing method in embodiments of this application includes: detecting, by a terminal, a beacon signal; and performing, by the terminal, an operation based on a detection result of the beacon signal, where the operation includes at least one of the following: reachability monitoring, mobility monitoring, location monitoring, measurement, and link monitoring in a sleep state.

### CROSS-REFERENCE TO RELATED APPLICATIONS

This application is a continuation of International Patent Application No. PCT/CN2023/140473, filed on Dec. 21, 2023, which claims priority to Chinese Patent Application No. 202211701768.2, filed in China on Dec. 28, 2022, which is incorporated herein by reference in its entirety.

### TECHNICAL FIELD

This application pertains to the field of communication technologies, and specifically relates to a signal processing method and apparatus, and a device.

### BACKGROUND

Beacon signals (beacon signals) are introduced in some communication systems. For example, beacon signals are introduced in some communication scenarios involving low power wake-up signals (Low Power Wake Up Signal, LP-WUS) and low power wake-up modules (which may also be referred to as low power wake-up receivers, Low Power Wake Up Receiver, LP-WUR).

### SUMMARY

According to a first aspect, a signal processing method is provided and includes:
detecting, by a terminal, a beacon signal; and
performing, by the terminal, an operation based on a detection result of the beacon signal, where the operation includes at least one of the following:
reachability monitoring, mobility monitoring, location monitoring, measurement, or link monitoring in a sleep state.

According to a second aspect, a signal processing apparatus is provided and includes:
a detection module, configured to detect a beacon signal; and
a first execution module, configured to perform an operation based on a detection result of the beacon signal, where the operation includes at least one of the following:
reachability monitoring, mobility monitoring, location monitoring, measurement, or link monitoring in a sleep state.

According to a third aspect, a terminal is provided. The terminal includes a processor and a memory. The memory stores a program or instructions capable of running on the processor. When the program or instructions are executed by the processor, the steps of the signal processing method provided in the embodiments of this application are implemented.

According to a fourth aspect, a terminal is provided and includes a processor and a communication interface. The communication interface is configured to detect a beacon signal. The processor is configured to perform an operation based on a detection result of the beacon signal, where the operation includes at least one of the following: reachability monitoring, mobility monitoring, location monitoring, measurement, or link monitoring in a sleep state.

According to a fifth aspect, a readable storage medium is provided. The readable storage medium stores a program or instructions. When the program or instructions are executed by a processor, the steps of the signal processing method provided in the embodiments of this application are implemented.

According to a sixth aspect, a chip is provided. The chip includes a processor and a communication interface. The communication interface is coupled to the processor. The processor is configured to run a program or instructions to implement the signal processing method provided in the embodiments of this application.

According to a seventh aspect, a computer program or program product is provided. The computer program or program product is stored in a storage medium. The computer program or program product is executed by at least one processor to implement the steps of the signal processing method provided in the embodiments of this application.

### BRIEF DESCRIPTION OF DRAWINGS

FIG. 1 is a block diagram of a wireless communication system to which an embodiment of this application may be applied;

FIG. 2 is a schematic structural diagram of a terminal to which an embodiment of this application may be applied;

FIG. 3 is a schematic structural diagram of a signal to which an embodiment of this application may be applied;

FIG. 4 is a flowchart of a signal processing method according to an embodiment of this application;

FIG. 5 is a structural diagram of a signal processing apparatus according to an embodiment of this application;

FIG. 6 is a structural diagram of a communication device according to an embodiment of this application; and

FIG. 7 is a structural diagram of another terminal according to an embodiment of this application.

### DESCRIPTION OF EMBODIMENTS

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a quantity of objects is not limited. For example, there may be one or more first objects. In addition, the term “and/or” in the specification and claims indicates at least one of connected objects, and the character “/” generally represents an “or” relationship between associated objects.

The term “indication” in the specification and claims of this application may be either an explicit indication or an implicit indication. The explicit indication may be understood as follows: A sender explicitly notifies a receiver, in a sent indication, of an operation to be performed or a result being requested. The implicit indication may be understood as follows: A receiver makes a decision based on an indication sent by a sender, and determines, based on a decision result, an operation to be performed or a result being requested.

It should be noted that technologies described in the embodiments of this application are not limited to a long term evolution (Long Term Evolution, LTE)/LTE-Advanced (LTE-Advanced, LTE-A) system, and can also be used in other wireless communication systems, such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency-division multiple access (Single-carrier Frequency-Division Multiple Access, SC-FDMA), and other systems. The terms “system” and “network” in the embodiments of this application are usually used interchangeably. The described technologies may be used for the foregoing systems and radio technologies, and may also be used for other systems and radio technologies. However, in the following descriptions, the new radio (New Radio, NR) system is described for an illustrative purpose, and NR terms are used in most of the following descriptions. These technologies may also be applied to other applications than an NR system application, for example, a 6th Generation (6th Generation, 6G) communication system.

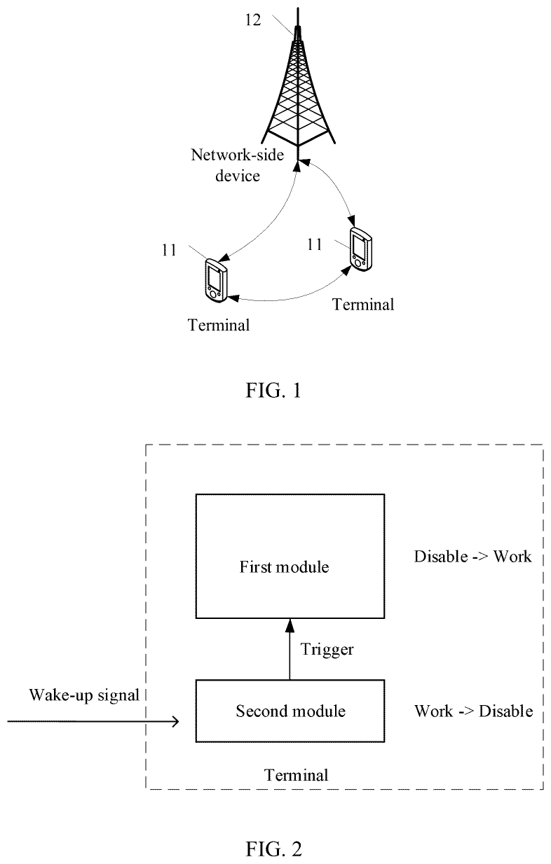

FIG. 1 is a block diagram of a wireless communication system to which an embodiment of this application may be applied. The wireless communication system includes a terminal 11 and a network-side device 12. The terminal 11 may be a terminal-side device such as a mobile phone, a tablet personal computer (Tablet Personal Computer), a laptop computer (Laptop Computer) or a notebook computer, a personal digital assistant (Personal Digital Assistant, PDA), a palmtop computer, a netbook, an ultra-mobile personal computer (ultra-mobile personal computer, UMPC), a mobile Internet device (Mobile Internet Device, MID), an augmented reality (augmented reality, AR) or virtual reality (virtual reality, VR) device, a robot, a wearable device (Wearable Device), vehicle user equipment (Vehicle User Equipment, VUE), pedestrian user equipment (Pedestrian User Equipment, PUE), a smart home (a home device having a wireless communication function, such as a refrigerator, a television, a washing machine, or furniture), a game console, a personal computer (personal computer, PC), a teller machine, or a self-service machine. The wearable device includes a smartwatch, a smart band, a smart headphone, smart glasses, smart jewelry (a smart bracelet, a smart wrist chain, a smart ring, a smart necklace, a smart anklet, a smart ankle chain, or the like), a smart wristband, smart clothing, or the like. It should be noted that a specific type of the terminal 11 is not limited in the embodiments of this application. The network-side device 12 may include an access network device or a core network device. The access network device may also be referred to as a radio access network device, a radio access network (Radio Access Network, RAN), a radio access network function, or a radio access network element. The access network device may include a base station, a wireless local area network (Wireless Local Area Network, WLAN) access point, a Wi-Fi node, or the like. The base station may be referred to as a NodeB, an evolved NodeB (eNB), an access point, a base transceiver station (Base Transceiver Station, BTS), a radio base station, a radio transceiver, a basic service set (Basic Service Set, BSS), an extended service set (Extended Service Set, ESS), a home NodeB, a home evolved NodeB, a transmission and reception point (Transmission Reception Point, TRP), or another appropriate term in the art. As long as the same technical effect is achieved, the base station is not limited to specific technical terms. It should be noted that in the embodiments of this application, only a base station in an NR system is used as an example for description, but a specific type of the base station is not limited. The core network device may include but is not limited to at least one of the following: a core network node, a core network function, a mobility management entity (Mobility Management Entity, MME), an access and mobility management function (Access and Mobility Management Function, AMF), a session management function (Session Management Function, SMF), a user plane function (User Plane Function, UPF), a policy control function (Policy Control Function, PCF), a policy and charging rules function (Policy and Charging Rules Function, PCRF), an edge application server discovery function (Edge Application Server Discovery Function, EASDF), unified data management (Unified Data Management, UDM), a unified data repository (Unified Data Repository, UDR), a home subscriber server (Home Subscriber Server, HSS), a centralized network configuration (Centralized network configuration, CNC), a network repository function (Network Repository Function, NRF), a network exposure function (Network Exposure Function, NEF), a local NEF (Local NEF or L-NEF), a binding support function (Binding Support Function, BSF), an application function (Application Function, AF), or the like. It should be noted that in the embodiments of this application, only a core network device in the NR system is used as an example for description, but a specific type of the core network device is not limited.

However, currently, a terminal cannot support an operation related to a beacon signal, resulting in poor communication performance of the terminal. Embodiments of this application provide a signal processing method and apparatus, and a device to resolve a problem that communication performance of a terminal is poor.

In the embodiments of this application, the terminal detects the beacon signal; and the terminal performs the operation based on the detection result of the beacon signal, where the operation includes at least one of the following: reachability monitoring, mobility monitoring, location monitoring, measurement, or link monitoring in the sleep state. In this way, the terminal can support at least one of reachability monitoring, mobility monitoring, location monitoring, measurement, or link monitoring in the sleep state based on the detection result of the beacon signal, thereby improving communication performance of the terminal.

In some embodiments, an LP-WUS may be received via an LP WUR and used to awaken a main communication module or the like. As shown in FIG. 2, a terminal includes two modules. The first module is a main communication module for receiving and sending mobile communication data. The second module is a low power wake-up receiving module for receiving a low power wake-up signal and a low power beacon signal sent by a transmit end. The low power wake-up signal may be used to awaken a main communication module at a receive end. The low power beacon signal may be used to provide time reference information and other information for receiving the low power wake-up signal, and may also provide wake-up link management.

As shown in FIG. 2, when the first module is not awakened by the second module, the first module remains in a disabled state and does not send or receive data. When downlink data arrives, the second module detects a wake-up signal sent by a transmit end, where the wake-up signal includes information of the terminal. In this case, the second module triggers the first module to switch from the disabled state to a working state to receive and send data. The second module may be enabled continuously or discontinuously. When the second module is enabled, the second module can receive a low power wake-up signal and a low power beacon signal.

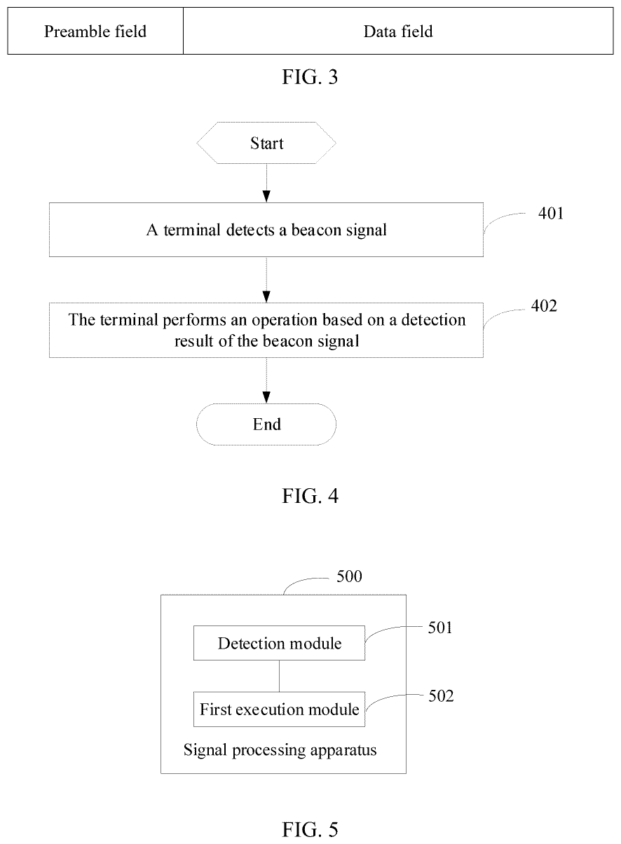

In some embodiments, a basic framework of the LP-WUS may be shown in FIG. 3, including:
a preamble field (Preamble field) and a data field (Data field).

A purpose of the preamble field includes but is not limited to at least one of detection, synchronization, or data rate (data rate) determination of the LP-WUS. In addition, the preamble may be further used to indicate a user identity, a user group identity, or the like. The data field may be used to carry a data part. In addition, the data field may further include at least one of the following:
the user identity or the user group identity, a specific bit for awakening the terminal, bits for carrying other functions, such as a system information update, an emergency message, a random access signal (Random Access Channel, RACH), or related operations after the terminal is awakened, where the related operations after the terminal is awakened may be: whether a synchronization signal block (Synchronization Signal Block, SSB) needs to be received, whether cell selection or reselection needs to be performed, whether system information needs to be received, and the like.

In embodiments of this application, a basic framework of the beacon signal may also be the framework shown in FIG. 3, including a preamble field (Preamble field) and a data field (Data field).

A signal processing method and apparatus, and a terminal provided in embodiments of this application are hereinafter described in detail by using some embodiments and application scenarios thereof with reference to the accompanying drawings.

FIG. 4 is a flowchart of a signal processing method according to an embodiment of this application. As shown in FIG. 4, the method includes the following steps.

Step 401: A terminal detects a beacon signal (beacon signal).

The beacon signal may be a beacon signal sent by a network side, and detecting the beacon signal may also be referred to as listening to the beacon signal.

Specifically, the terminal may detect the beacon signal through blind detection.

The detected beacon signal may include one or more sequences.

The beacon signal (beacon signal) may be a separate signal different from an LP-WUS, or may be part of an LP-WUS. For example, in some embodiments, the LP-WUS includes a preamble (preamble) part and a data (data) part, and a beacon may be a preamble part of the LP-WUS.

Step 402: The terminal performs an operation based on a detection result of the beacon signal, where the operation includes at least one of the following:

reachability (reachability) monitoring, mobility monitoring, location monitoring, measurement, or link monitoring in a sleep state.

The reachability monitoring may be: performing terminal reachability monitoring based on the detection result of the beacon signal, for example, determining whether the terminal is reachable or unreachable. The term “reachable” (reachable) may be understood as signal reachability between the terminal and the network side or connection (Connection) reachability between the terminal and the network side, for example, the terminal can detect a signal sent by the network side, or the terminal can send a signal to the network side. The term “unreachable” (unreachable) may be understood as signal unreachability between the terminal and the network side or connection (Connection) unreachability between the terminal and the network side, for example, the terminal cannot detect a signal sent by the network side, or the terminal cannot send a signal to the network side.

The mobility monitoring may be: performing terminal mobility monitoring based on the detection result of the beacon signal, for example, determining whether the terminal moves out of a range.

The location monitoring may be: monitoring a location range of the terminal based on the detection result of the beacon signal, for example, determining whether a current location of the terminal is updated.

The measurement may be: determining a measurement condition based on the detection result of the beacon signal, for example, determining whether to perform cell selection or reselection, whether to enable neighboring cell measurement, whether to perform measurement relaxation or enhancement, or whether to perform other related operations based on determination of a measurement result. Specifically, it may be measurement performed based on the beacon signal, for example, radio resource management (Radio Resource Management, RRM) measurement performed based on the beacon signal.

The link monitoring in the sleep state may be: performing link monitoring in a low power sleep (LP-Sleep) state based on the detection result of the beacon signal, for example, performing radio link monitoring (Radio Link Monitoring, RLM) based on the beacon signal. Specifically, the RLM based on the beacon signal herein may be the same as or different from RLM defined in a protocol. For example, the RLM based on the beacon signal may be RLM based on in-synchronization (In-sync) and out-of-synchronization (Out-of-sync) defined in a protocol. In other words, when a corresponding condition defined in a protocol is met, a radio link failure (Radio Link Failure, RLF) may be triggered. The RLM based on the beacon signal may alternatively be newly defined link monitoring in the LP-sleep state, and used to monitor quality of a link between the terminal and the network side in the LP-sleep state. When there is a link quality problem, the terminal exits the LP-sleep state or returns to an idle/inactive (Idle/inactive) state. When there is no link quality problem, the terminal continues to stay in the LP-sleep state or continues to listen to an LP-WUS signal.

The detection result may indicate whether the beacon signal is detected, or may indicate a quantity of detected sequences of the beacon signal, or may indicate feature information of a sequence of the beacon signal, or the like.

In this embodiment of this application, through the foregoing steps, the terminal can support at least one of reachability monitoring, mobility monitoring, location monitoring, measurement, or link monitoring in the sleep state based on the detection result of the beacon signal, thereby improving communication performance of the terminal.

In an optional implementation, that the terminal performs an operation based on a detection result of the beacon signal includes at least one of the following:
in a case that one sequence of the beacon signal is detected, the terminal performs the operation based on the one sequence; or
in a case that a plurality of sequences of the beacon signal are detected, the terminal performs the operation based on a target sequence among the plurality of sequences, where the target sequence is one or more of the plurality of sequences.

In a case that one sequence of the beacon signal is detected, the terminal performs the operation based on the one sequence may be: in a case that a plurality of beacon signals are configured, if one sequence is detected, the operation is performed based on the one sequence.

In this implementation, because the terminal performs the operation based on the one sequence, power consumption of the terminal can be reduced. For example, when the terminal is enabled to move within ranges of different cells or areas by configuring a plurality of beacon signals, the terminal only needs to perform reachability monitoring, mobility monitoring, location monitoring, measurement, and link monitoring in the sleep state based on the one sequence. In this way, the terminal does not need to be awakened frequently, thereby further reducing the power consumption of the terminal.

The target sequence may be part or all of the plurality of sequences, and specifically, one or more of the plurality of sequences. In a case of a plurality of target sequences, it may be understood that the operation is performed based on a plurality of detected sequences.

In this implementation, because the operation is performed based on the target sequence among the plurality of sequences, it is not necessary to perform the operation based on all sequences, thereby reducing the power consumption of the terminal.

In some implementations, if the target sequence of the beacon signal is detected, the terminal performs the operation based on the detected target sequence.

In some implementations, the target sequence may be any one or more sequences of the beacon signal.

In some implementations, the target sequence includes at least one of the following:
a sequence whose signal reception quality meets a preset condition among the plurality of sequences;
a sequence corresponding to the terminal among the plurality of sequences; or
a sequence indicated by a network.

The sequence indicated by the network may be one or more indicated sequences.

The sequence whose signal reception quality meets the preset condition among the plurality of sequences may include at least one of the following:
a sequence with best signal reception quality among the plurality of sequences, or a preset quantity of sequences with best signal reception quality among the plurality of sequences; or
a sequence with signal reception quality higher than or equal to a preset threshold among the plurality of sequences, or N sequences with signal reception quality higher than or equal to a preset threshold among the plurality of sequences, where N is a positive integer not exceeding a preset quantity value.

The reception quality may include at least one of the following:
reference signal received power (Reference Signal Receiving Power, RSRP), reference signal received quality (Reference Signal Receiving Quality, RSRQ), a signal to interference plus noise ratio (Signal to Interference plus Noise Ratio, SINR), a received level value, signal strength, or a preset measurement quantity.

The preset measurement quantity may be a newly defined measurement quantity other than the foregoing measurement performance.

Values of the preset threshold, the preset quantity, and N may be specified in a protocol or configured by the network side.

The N sequences with signal reception quality higher than or equal to the preset threshold among the plurality of sequences may be one or more sequences with signal reception quality higher than or equal to the preset threshold.

Reliability of the operation can be improved by performing the operation based on the reception quality.

The sequence corresponding to the terminal among the plurality of sequences includes at least one of the following:
a sequence corresponding to a cell, a public land mobile network (Public Land Mobile Network, PLMN), or an area corresponding to the terminal among the plurality of sequences;
a sequence associated with the terminal among the plurality of sequences; or
a sequence corresponding to a group to which the terminal belongs among the plurality of sequences.

The cell, the PLMN, or the area corresponding to the terminal may include at least one of the following:
a cell, a PLMN, or an area on which the terminal camps;
a cell, a PLMN, or an area stored by the terminal;
a cell, a PLMN, or an area in which the terminal is located when the terminal enters the low power LP-sleep state;
a cell, a PLMN, or an area in which the terminal is located before the terminal enters the LP-sleep state; or
a cell, a PLMN, or an area configured by the network for the terminal.

In this way, the operation may be based on only the cell, the PLMN, or the area corresponding to the terminal, and reliability of the operation can be further ensured.

The area may include at least one of the following:
an access network notification area (Ran notification area, RNA), a group of cells, an area corresponding to a TRP, an area corresponding to a group of TRPs, a distributed unit (Distributed Unit, DU) range, a centralized unit (Centralized Unit, CU) range, or a preset area range.

The sequence associated with the terminal may be a sequence corresponding to the terminal itself. This correspondence or association relationship may be specified in a protocol or configured by the network side.

In this embodiment of this application, the correspondence between the sequence and the cell, the PLMN, the area, the terminal, or the group may be specified in a protocol or configured by the network side.

By using the sequence corresponding to the terminal, the basis for the terminal to perform the operation can be made terminal-specific, and reliability of the operation can be further ensured.

In an optional implementation, that the terminal performs an operation based on a detection result of the beacon signal includes:
in a case that a plurality of sequences of the beacon signal are detected, determining a monitoring result of the terminal based on a monitoring result of at least one sequence.

The monitoring result of each sequence may be: in a case that sequences are detected, monitoring these detected sequences, or detection for each sequence includes monitoring of the sequence.

In some implementations, each of the plurality of sequences may be monitored. For example, for each sequence, at least one of the following types of monitoring may be performed:
reachability monitoring, link monitoring, mobility monitoring, or location range monitoring.

In some implementations, the at least one sequence may be monitored, and for the at least one sequence, at least one of the following types of monitoring is performed:
reachability monitoring, link monitoring, mobility monitoring, or location range monitoring.

The at least one sequence may be the plurality of sequences, or may be the target sequence in the foregoing implementation, or at least one sequence determined by other means.

A corresponding monitoring result may be obtained by monitoring each sequence, and then a final monitoring result of the terminal is determined based on a monitoring result of at least one sequence. For example, the monitoring result of the terminal may include at least one of the following:
a reachability monitoring result, a link monitoring result, a mobility monitoring result, or a location range monitoring result.

In this implementation, because the monitoring result of the terminal needs to be determined based on only the monitoring result of the at least one sequence, the power consumption of the terminal can be reduced.

Optionally, the determining a monitoring result of the terminal based on a monitoring result of at least one sequence includes at least one of the following:
determining reachability of the terminal, a link state of the terminal, and the location range of the terminal based on a monitoring result of one sequence;
determining reachability of the terminal, a link state of the terminal, and the location range of the terminal based on monitoring results of the plurality of sequences; or
determining reachability of the terminal, a link state of the terminal, and the location range of the terminal based on monitoring results of a preset quantity of sequences.

The one sequence may be any one of the plurality of sequences, or a special sequence, such as the target sequence. Because the determining may be based on a monitoring result of one of the sequences, the power consumption of the terminal can be reduced.

The determining based on the monitoring results of the plurality of sequences can improve accuracy of the monitoring result.

The preset quantity may be specified in a protocol or configured by the network side. The determining based on the monitoring results of the preset quantity of sequences can improve accuracy of the monitoring result.

Optionally, the monitoring result of the terminal may meet at least one of the following:
if the monitoring result of the one sequence indicates that the terminal is reachable or that the link is normal, determining that the terminal is reachable or that the link is normal;
if the monitoring results of the plurality of sequences all indicate that the terminal is reachable or that the link is normal, determining that the terminal is reachable or that the link is normal;
if the monitoring results of the preset quantity of sequences indicate that the terminal is reachable or that the link is normal, determining that the terminal is reachable or that the link is normal;
if the monitoring result of the one sequence indicates that the terminal is unreachable or that the link is abnormal, determining that the terminal is unreachable or that the link is abnormal;
if the monitoring results of the plurality of sequences all indicate that the terminal is unreachable or that the link is abnormal, determining that the terminal is unreachable or that the link is abnormal;
if the monitoring results of the preset quantity of sequences indicate that the terminal is unreachable or that the link is abnormal, determining that the terminal is unreachable or that the link is abnormal;
if the monitoring result of the one sequence indicates that the terminal does not move out of the location range or has no location update, determining that the terminal does not move out of the location range or has no location update;
if the monitoring results of the plurality of sequences all indicate that the terminal does not move out of the location range or has no location update, determining that the terminal does not move out of the location range or has no location update;
if the monitoring results of the preset quantity of sequences indicate that the terminal is not out of the location range or has no location update, determining that the terminal is not out of the location range or has no location update;
if the monitoring result of the one sequence indicates that the terminal moves out of the location range or has a location update, determining that the terminal moves out of the location range or has the location update;
if the monitoring results of the plurality of sequences all indicate that the terminal moves out of the location range or has a location update, determining that the terminal moves out of the location range or has the location update; or
if the monitoring results of the preset quantity of sequences indicate that the terminal moves out of the location range or has a location update, determining that the terminal moves out of the location range or has the location update.

The preset quantity may be specified in a protocol or configured by the network side.

The terminal reachability may be understood as the signal reachability between the terminal and the network side. For example, the terminal can detect a signal sent by the network side, or the terminal can send a signal to the network side. Terminal unreachability may be understood as the signal unreachability between the terminal and the network side. For example, the terminal cannot detect a signal sent by the network side, or the terminal cannot send a signal to the network side.

In the foregoing implementation, it is determined, based on the one sequence, the preset quantity of sequences, or the plurality of sequences, that the terminal is unreachable, or that the link is abnormal, or that the terminal is reachable, or that the link is normal. In this way, the reachability of the terminal can be flexibly determined, or the link can be monitored. In addition, the power consumption of the terminal can be reduced, or accuracy of reachability or link monitoring of the terminal can be improved.

In some implementations, that the terminal performs reachability monitoring or link monitoring based on the plurality of sequences may include at least one of the following:
the terminal performs reachability monitoring for each sequence, and if reachability is determined based on one sequence, the terminal is reachable, or the link is normal;
the terminal performs reachability monitoring for each sequence, and if reachability is determined based on all sequences, the terminal is reachable, or the link is normal;
the terminal performs reachability monitoring for each sequence, and if reachability is determined based on a preset quantity of sequences, the terminal is reachable, or the link is normal, where the preset quantity is specified in a protocol or configured by the network;
the terminal performs reachability monitoring for each sequence, and if unreachability is determined based on one sequence, the terminal is unreachable, or the link is abnormal;
the terminal performs reachability monitoring for each sequence, and if unreachability is determined based on all sequences, the terminal is unreachable, or the link is abnormal; or
the terminal performs reachability monitoring for each sequence, and if unreachability is determined based on a preset quantity of sequences, the terminal is unreachable, or the link is abnormal.

The moving out of the location range may be: the terminal is not within a range of a current cell, or the terminal is not within a current location area, or the like. The not moving out of the location range may be: the terminal is within the range of the current cell, or the terminal is within the current location area, or the like.

The location update may indicate that the terminal has a location change, and no location update may indicate that the terminal has no location change.

In the foregoing implementation, it is determined, based on the one sequence, the preset quantity of sequences, or the plurality of sequences, that the terminal does not move out of the location range or has no location update, or that the terminal moves out of the location range or has the location update. In this way, the mobility of the terminal can be flexibly monitored. In addition, the power consumption of the terminal can be reduced, and accuracy of the mobility monitoring of the terminal can be improved.

In some implementations, that the terminal performs mobility monitoring or location range monitoring based on the plurality of sequences includes at least one of the following:
the terminal performs mobility monitoring or location range monitoring for each sequence, and if it is determined, based on one sequence, that the terminal does not move out of the range or has no location update, the terminal does not move out of the range or has no location update;
the terminal performs mobility monitoring or location range monitoring for each sequence, and if it is determined, based on all sequences, that the terminal does not move out of the range or has no location update, the terminal does not move out of the range or has no location update;
the terminal performs mobility monitoring or location range monitoring for each sequence, and if it is determined, based on a preset quantity of sequences, that the terminal does not move out of the range or has no location update, the terminal does not move out of the range or has no location update, where the preset quantity is specified in a protocol or configured by the network;
the terminal performs mobility monitoring or location range monitoring for each sequence, and if it is determined, based on one sequence, that the terminal moves out of the range or has a location update, the terminal moves out of the range or has the location update;
the terminal performs mobility monitoring or location range monitoring for each sequence, and if it is determined, based on all sequences, that the terminal moves out of the range or has a location update, the terminal moves out of the range or has the location update; or
the terminal performs mobility monitoring or location range monitoring for each sequence, and if it is determined, based on a preset quantity of sequences, that the terminal moves out of the range or has a location update, the terminal moves out of the range or has the location update.

In an optional implementation, that the terminal performs an operation based on a detection result of the beacon signal includes:
in a case that a plurality of sequences of the beacon signal are detected, determining, based on a measurement result of at least one sequence, whether to perform a measurement-associated behavior.

A measurement result of each sequence may be: in a case that sequences are detected, measuring these detected sequences; or detection for each sequence includes measurement of the sequence.

The at least one sequence may be the plurality of sequences, or may be the target sequence in the foregoing implementation, or at least one sequence determined by other means.

The determining, based on a measurement result of at least one sequence, whether to perform a measurement-associated behavior in a case that a plurality of sequences of the beacon signal are detected may be: in a case of the plurality of sequences, measuring each sequence, and then determining, based on the measurement result of the at least one sequence, whether to perform the measurement-associated behavior.

The determining whether to perform the measurement-associated behavior may be: determining whether the measurement result meets a measurement result condition corresponding to the measurement-associated behavior, and if yes, determining to perform the measurement-associated behavior, or else, determining not to perform the measurement-associated behavior.

The determining, based on the measurement result of the at least one sequence, the measurement behavior of the terminal may include at least one of the following:
determining, based on a measurement result of one sequence, whether to perform the measurement-associated behavior; or
determining, based on measurement results of the plurality of sequences, whether to perform the measurement-associated behavior.

The one sequence may be any one of the plurality of sequences, or a special sequence, such as the target sequence. Because whether to perform the measurement-associated behavior is determined based on a measurement result of one of the sequences, the power consumption of the terminal can be reduced.

The determining based on the monitoring results of the plurality of sequences can improve accuracy of the measurement.

Optionally, the at least one sequence includes a plurality of sequences, and the determining, based on measurement results of the plurality of sequences, whether to perform the measurement-associated behavior includes at least one of:
determining, based on a combined value of the measurement results of the plurality of sequences, whether to perform the measurement-associated behavior;
determining, based on a measurement result of each of the plurality of sequences, whether to perform the measurement-associated behavior; or
determining, based on measurement results of a preset quantity of sequences among the plurality of sequences, whether to perform the measurement-associated behavior.

The combined value of the measurement results of the plurality of sequences may be a combined value such as an average value, a sum, or a weighted average value of the measurement results of the plurality of sequences.

In this implementation, accuracy of the measurement can be improved by determining, based on the combined value of the measurement results of the plurality of sequences or the measurement result of each of the plurality of sequences, whether to perform the measurement-associated behavior.

The power consumption of the terminal can be reduced by determining, based on the measurement results of the preset quantity of sequences, whether to perform the measurement-associated behavior.

In some implementations, the at least one sequence includes a plurality of sequences, and the determining, based on measurement results of the plurality of sequences, whether to perform a measurement-associated behavior includes at least one of the following:
if a measurement result of one of the plurality of sequences meets the measurement condition, determining to perform the measurement-associated behavior;
if the measurement results of the plurality of sequences all meet the measurement condition, determining to perform the measurement-associated behavior;
if measurement results of a preset quantity of sequences among the plurality of sequences meet the measurement condition, determining to perform the measurement-associated behavior;
if a measurement result of one of the plurality of sequences does not meet the measurement condition, determining not to perform the measurement-associated behavior;
if a measurement result of none of the plurality of sequences meets the measurement condition, determining not to perform the measurement-associated behavior; or
if measurement results of a preset quantity of sequences among the plurality of sequences do not meet the measurement condition, determining not to perform the measurement-associated behavior.

If the measurement result of one of the plurality of sequences meets the measurement condition, and that of another sequence does not meet the measurement condition, it may be determined, based on a protocol specification or a network-side configuration, to perform the measurement-associated behavior or not to perform the measurement-associated behavior.

The measurement condition may also be referred to as a measurement result condition. The measurement condition may be specified in a protocol or configured by the network side, and corresponding measurement conditions may be configured for different measurement-associated behaviors.

The power consumption of the terminal can be reduced by determining, based on the measurement result of one sequence, whether to perform the measurement-associated behavior. For example, the terminal measures each sequence, and determines, based on the measurement result of one sequence, whether a corresponding measurement result condition is met. If the measurement result condition is met, the terminal determines to perform the measurement-associated behavior, or else, determines not to perform the measurement-associated behavior.

Accuracy of the measurement can be improved by determining, based on the measurement results of the plurality of sequences, whether to perform the measurement-associated behavior. For example, the terminal measures each sequence, and determines, based on the measurement results of all sequences, whether a corresponding measurement result condition is met. If the measurement result condition is met, the terminal determines to perform the measurement-associated behavior, or else, determines not to perform the measurement-associated behavior.

In addition, the measurement condition may include any condition for determining based on a measurement result, such as a measurement condition for determining whether to perform cell selection or reselection, a measurement condition for determining whether to enable neighboring cell measurement, or a measurement condition for determining whether to perform measurement relaxation or enhancement.

Optionally, the measurement-associated behavior includes at least one of the following:
cell selection, cell reselection, serving cell measurement, neighboring cell measurement, measurement reporting, measurement relaxation, measurement enhancement, or whether to enable the measurement.

The measurement condition may be a corresponding measurement condition for determining at least one measurement-associated behavior. The measurement condition may be specified in a protocol or configured by the network side.

In this implementation, it may be determined, based on one or more sequences of the beacon signal, whether to perform cell selection, cell reselection, serving cell measurement, neighboring cell measurement, measurement reporting, measurement relaxation, measurement enhancement, or measurement enablement, thereby improving the measurement performance of the terminal.

In an optional implementation, in a case that the terminal is capable of receiving at least one sequence of the beacon signal, the terminal is reachable, the link is normal, or the terminal is capable of receiving an LP-WUS; or in a case that the terminal is capable of receiving a target sequence of the beacon signal, the terminal is reachable, the link is normal, or the terminal is capable of receiving an LP-WUS; and/or
in a case that the terminal is incapable of receiving at least one sequence of the beacon signal, the terminal is unreachable, the link is abnormal, or the terminal is incapable of receiving an LP-WUS; or in a case that the terminal is incapable of receiving a target sequence of the beacon signal, the terminal is unreachable, the link is abnormal, or the terminal is incapable of receiving an LP-WUS.

The at least one sequence may be any one or more sequences of the beacon signal.

For the target sequence, refer to the target sequence described in the foregoing implementation. Details are not described herein again.

That the terminal is incapable of receiving an LP-WUS may include at least one of the following:
the terminal is incapable of receiving an LP-WUS signal corresponding to a current cell; or
the terminal is incapable of receiving an LP-WUS signal corresponding to one or more sequences or a preset sequence of the beacon signal.

The current cell may include at least one of the following:
a cell on which the terminal currently camps;
a cell stored by the terminal;
a cell in which the terminal is located when the terminal enters the LP-sleep state;
a cell in which the terminal is located before the terminal enters the LP-sleep state;
a cell in which the terminal listens to an LP-WUS; or
a cell in which the terminal stores system information.

In this implementation, based on the at least one sequence or the target sequence, it is determined that the terminal is reachable, or that the link is normal, or that the terminal is capable of receiving the LP-WUS, or it is determined that the terminal is unreachable, or that the link is abnormal, or that the terminal is incapable of receiving the LP-WUS. Therefore, monitoring performance of the terminal is improved. For example, if the terminal is capable of receiving the one or more sequences, the preset sequence, or the target sequence of the beacon signal, it is determined that the terminal is reachable, or that the link is normal, or that the terminal is capable of receiving the LP-WUS; or if the terminal is incapable of receiving the one or more sequences, the preset sequence, or the target sequence of the beacon signal, it is determined that the terminal is unreachable, or that the link is abnormal, or that the terminal is incapable of receiving the LP-WUS.

In an optional implementation, the method further includes at least one of the following:
in a case that it is determined that the terminal is reachable, or that the link is normal, or that the terminal is capable of receiving an LP-WUS, monitoring a wake-up signal;
in a case that it is determined that the terminal is reachable, or that the link is normal, or that the terminal is capable of receiving an LP-WUS, remaining in the sleep state;
in a case that it is determined that the terminal is unreachable or that the link is abnormal, awakening or enabling a main receiver or a main receiving module;
in a case that it is determined that the terminal is unreachable, or that the link is abnormal, or that the terminal is incapable of receiving an LP-WUS, receiving system information;
in a case that it is determined that the terminal is unreachable, or that the link is abnormal, or that the terminal is incapable of receiving an LP-WUS, performing a tracking area update;
in a case that it is determined that the terminal is unreachable, or that the link is abnormal, or that the terminal is incapable of receiving an LP-WUS, performing cell selection or reselection;
in a case that it is determined that the terminal is unreachable, or that the link is abnormal, or that the terminal is incapable of receiving an LP-WUS, performing PLMN selection or reselection;
in a case that it is determined that the terminal is unreachable, or that the link is abnormal, or that the terminal is incapable of receiving an LP-WUS, entering the idle state or the inactive state;
in a case that it is determined that the terminal is unreachable, or that the link is abnormal, or that the terminal is incapable of receiving an LP-WUS, deactivating or disabling a low power wake-up function;
in a case that it is determined that the terminal is unreachable, or that the link is abnormal, or that the terminal is incapable of receiving an LP-WUS, exiting the sleep state; or
in a case that it is determined that the terminal is unreachable, or that the link is abnormal, or that the terminal is incapable of receiving an LP-WUS, skipping or ignoring a wake-up signal.

In this implementation, in a case that the terminal is reachable, or that the link is normal, or that the terminal is capable of receiving the LP-WUS, the terminal can monitor the wake-up signal while remaining in the sleep state, thereby reducing the power consumption of the terminal, without affecting communication performance of the terminal.

In this implementation, in a case that the terminal is unreachable, or that the link is abnormal, or that the terminal is incapable of receiving the LP-WUS, at least one of the following can be performed:
awakening or enabling the main receiver or the main receiving module;
receiving the system information;
performing the tracking area update (Tracking area update, TAU);
performing the cell selection or reselection (Cell selection/reselection);
performing the PLMN selection or reselection (PLMN selection/reselection);
entering the idle state or the inactive state;
deactivating or disabling an LP-WUS function (LP-WUS disable);
exiting the LP-sleep state; or
skipping or ignoring the LP-WUS (Skip LP-WUS).

In this implementation, because at least one of the foregoing is performed in the case that the terminal is unreachable, or that the link is abnormal, or that the terminal is incapable of receiving the LP-WUS, communication performance of the terminal can be improved, and incorrect processing of some signals by the terminal can be avoided.

In an optional implementation, in a case that at least one sequence of the beacon signal that the terminal is capable of receiving corresponds to a current cell of the terminal, it is determined that the terminal is not out of the location range or has no location update; and/or
in a case that the terminal is incapable of receiving at least one sequence of the beacon signal corresponding to a current cell of the terminal, it is determined that the terminal moves out of the location range or has a location update; or in a case that the terminal is incapable of receiving a target sequence of the beacon signal, it is determined that the terminal moves out of the location range or has a location update.

The at least one sequence may be any one or more sequences of the beacon signal, or may be the target sequence. For example, if sequences of a first signal received by the terminal includes one or more sequences corresponding to the current cell of the terminal, the terminal is not out of the location range or has no location update; or if the terminal is incapable of receiving one or more sequences, a preset sequence, or a target sequence of a first signal corresponding to the current cell of the terminal, the terminal moves out of the location range or has a location update.

For the current cell, refer to the description of the foregoing implementation. Details are not described herein again.

Not moving out of the location range or having no location update may mean that the terminal is within the range of the current cell.

Moving out of the location range or having a location update may mean that the terminal is not within the range of the current cell.

Based on the at least one sequence, accuracy of mobility monitoring of the terminal can be improved.

In an optional implementation, the method further includes at least one of the following:
in a case that the terminal does not move out of the location range or has no location update, determining that the terminal is within a range of a current cell;
in a case that the terminal does not move out of the location range or has no location update, monitoring a wake-up signal;
in a case that the terminal does not move out of the location range or has no location update, remaining in the sleep state;
in a case that the terminal moves out of the location range or has a location update, determining that the terminal is not within a range of a current cell;
in a case that the terminal moves out of the location range or has a location update, determining that the terminal is unreachable or incapable of receiving an LP-WUS;
in a case that the terminal moves out of the location range or has a location update, awakening or enabling a main receiver or a main receiving module;
in a case that the terminal moves out of the location range or has a location update, receiving system information;
in a case that the terminal moves out of the location range or has a location update, performing a tracking area update;
in a case that the terminal moves out of the location range or has a location update, performing cell selection or reselection;
in a case that the terminal moves out of the location range or has a location update, performing PLMN selection or reselection;
in a case that the terminal moves out of the location range or has a location update, entering the idle state or the inactive state;
in a case that the terminal moves out of the location range or has a location update, deactivating or disabling a low power wake-up function;
in a case that the terminal moves out of the location range or has a location update, exiting the sleep state; or
in a case that the terminal moves out of the location range or has a location update, skipping or ignoring a wake-up signal.

That the terminal is incapable of receiving an LP-WUS may include at least one of the following:
the terminal is incapable of receiving an LP-WUS signal corresponding to the current cell; or
the terminal is incapable of receiving an LP-WUS signal corresponding to one or more sequences or a preset sequence of the beacon signal.

In this implementation, in a case that the terminal does not move out of the location range or has no location update, the terminal can monitor the wake-up signal while remaining in the sleep state, thereby reducing the power consumption of the terminal, without affecting communication performance of the terminal.

In this implementation, in a case that the terminal is unreachable, or that the link is abnormal, or that the terminal is incapable of receiving the LP-WUS, at least one of the following can be performed:
awakening or enabling the main receiver or the main receiving module;
receiving the system information;
performing the tracking area update (Tracking area update, TAU);
performing the cell selection or reselection (Cell selection/reselection);
performing the PLMN selection or reselection (PLMN selection/reselection);
entering the idle state or the inactive state;
deactivating or disabling an LP-WUS function (LP-WUS disable);
exiting the LP-sleep state; or
skipping or ignoring the LP-WUS (Skip LP-WUS).

In this implementation, because at least one of the foregoing is performed in the case that the terminal moves out of the location range or has the location update, communication performance of the terminal can be improved, and incorrect processing of some signals by the terminal can be avoided.

In an optional implementation, the method further includes:
the terminal receives indication information sent by the network side; and
that the terminal performs an operation based on a detection result includes:
the terminal performs the operation based on the indication information and the detection result.

The indication information may explicitly or implicitly configure the terminal to perform the operation based on the detection result.

In this implementation, the operation is performed based on the indication information and the detection result, so that the terminal and the network side can have a consistent understanding about the terminal behavior of performing the operation, to improve communication performance between the terminal and the network side.

In some implementations, the indication information is used to explicitly configure the terminal to perform the operation based on the detection result. That the indication information is used to explicitly configure the terminal to perform the operation based on the detection result may be understood as follows: The indication information explicitly instructs the terminal to perform the operation based on the detection result. Alternatively, the indication information explicitly instructs the terminal to specifically perform one or more of the following operations based on the detection result: reachability monitoring, mobility monitoring, location monitoring, measurement, and link monitoring in the sleep state.

In some implementations, the indication information is used to instruct the terminal to enable a function of performing the operation based on the detection result. In this way, the terminal enables the function based on the indication information, so that consistency of the understanding between the terminal and the network side about the operation can be improved.

In some implementations, the indication information is used to configure sequences of a plurality of beacon signals, to implicitly instruct the terminal to perform the operation based on a detection result of a beacon signal among the plurality of beacon signals. In these implementations, the indication information may be another message different from a configuration message of the beacon signal, or the indication information itself may be a configuration message of the beacon signal and is used to configure sequence-related information of the beacon signal.

The plurality of beacon signals include the beacon signal detected by the terminal in step 401. Therefore, if the terminal detects the sequence of the beacon signal among the plurality of beacon signals, the terminal can perform the operation based on the detection result, so that the terminal is restricted from performing the operation based on the detection result of the beacon signal in a specific scenario, thereby further ensuring reachability and mobility performance of the terminal and ensuring service interruption and delay performance while reducing the power consumption of the terminal.

In some implementations, the indication information is used to configure a target sequence of the beacon signal corresponding to the terminal, to instruct the terminal to perform the operation based on a detection result of the target sequence of the beacon signal. In these implementations, the indication information may be another message different from a configuration message of the beacon signal, or the indication information itself may be a configuration message of the beacon signal and is used to configure the target sequence of the beacon signal corresponding to the terminal.

The beacon signal corresponding to the terminal may be one or more beacon signals corresponding to a cell, a PLMN, or an area in which the terminal is located. For the target sequence, refer to the corresponding description of the foregoing implementation. Details are not described herein again. In this way, if the terminal receives a sequence of the one or more beacon signals corresponding to the cell, the PLMN, or the area in which the terminal is located, which is configured by the network side, the terminal performs the operation based on the detection result of the beacon signal, so that the terminal is restricted from performing the operation based on the detection result of the beacon signal in a specific scenario, thereby further ensuring reachability and mobility performance of the terminal and ensuring service interruption and delay performance while reducing the power consumption of the terminal. In these implementations, the indication information may be another message different from a configuration message of the beacon signal, or the indication information itself may be a configuration message of the beacon signal and is used to configure the sequence of the one or more beacon signals corresponding to the cell, the PLMN, or the area in which the terminal is located.

It should be noted that, in some implementations, the operation performed by the terminal based on the detection result may alternatively be performed based on a protocol specification.

In an optional implementation, the method further includes:
the terminal receives configuration information sent by the network side, where the configuration information is used to configure at least one of the following:
a correspondence between the beacon signal and a cell;
a correspondence between the beacon signal and a PLMN;
a correspondence between the beacon signal and an area; or
a configuration of the beacon signal.

The configuration of the beacon signal may include:
sequence information of the beacon signal, a sequence corresponding to the terminal, or at least one of a time-domain resource, a frequency-domain resource, or a spatial resource for detecting or listening to the beacon signal.

In an optional implementation, some or all of the foregoing configuration information may be specified in a protocol.

In this implementation, based on the configuration information, the terminal can accurately determine the beacon signal corresponding to the terminal, thereby improving accuracy of monitoring or measurement of the terminal.

It should be noted that content of the configuration information may alternatively be specified in a protocol.

In the embodiments of this application, the terminal detects the beacon signal; and the terminal performs the operation based on the detection result of the beacon signal, where the operation includes at least one of the following: reachability monitoring, mobility monitoring, location monitoring, measurement, or link monitoring in the sleep state. In this way, the terminal can support at least one of reachability monitoring, mobility monitoring, location monitoring, measurement, or link monitoring in the sleep state based on the detection result of the beacon signal, thereby improving communication performance of the terminal.

The signal detection result processing apparatus method provided in the embodiments of this application may be performed by a virtual apparatus. A signal detection result processing apparatus provided in the embodiments of this application is described by assuming that the signal detection result processing apparatus method is performed by the virtual apparatus in the embodiments of this application.

FIG. 5 is a structural diagram of a signal processing apparatus according to an embodiment of this application. As shown in FIG. 5, the signal processing apparatus 500 includes:
a detection module 501, configured to detect a beacon signal; and
a first execution module 502, configured to perform an operation based on a detection result of the beacon signal, where the operation includes at least one of the following:
reachability monitoring, mobility monitoring, location monitoring, measurement, or link monitoring in a sleep state.

Optionally, the first execution module 502 is configured to perform at least one of the following:
in a case that one sequence of the beacon signal is detected, performing the operation based on the one sequence; or
in a case that a plurality of sequences of the beacon signal are detected, performing the operation based on a target sequence among the plurality of sequences, where the target sequence is one or more of the plurality of sequences.

Optionally, the target sequence includes at least one of the following:
a sequence whose signal reception quality meets a preset condition among the plurality of sequences;
a sequence corresponding to the terminal among the plurality of sequences; or
a sequence indicated by a network.

Optionally, the sequence whose signal reception quality meets the preset condition among the plurality of sequences includes at least one of the following:
a sequence with best signal reception quality among the plurality of sequences, or a preset quantity of sequences with best signal reception quality among the plurality of sequences; or
a sequence with signal reception quality higher than or equal to a preset threshold among the plurality of sequences, or N sequences with signal reception quality higher than or equal to a preset threshold among the plurality of sequences, where N is a positive integer not exceeding a preset quantity value; and/or
the sequence corresponding to the terminal among the plurality of sequences includes at least one of the following:
a sequence corresponding to a cell, a public land mobile network PLMN, or an area corresponding to the terminal among the plurality of sequences;
a sequence associated with the terminal among the plurality of sequences; or
a sequence corresponding to a group to which the terminal belongs among the plurality of sequences.

Optionally, the cell, the PLMN, or the area corresponding to the terminal includes at least one of the following:
a cell, a PLMN, or an area on which the terminal camps;
a cell, a PLMN, or an area stored by the terminal;
a cell, a PLMN, or an area in which the terminal is located when the terminal enters a low power LP-sleep state;
a cell, a PLMN, or an area in which the terminal is located before the terminal enters the LP-sleep state; or
a cell, a PLMN, or an area configured by the network for the terminal.

Optionally, the first execution module 502 is configured to:
in a case that a plurality of sequences of the beacon signal are detected, determine a monitoring result of the terminal based on a monitoring result of at least one sequence.

Optionally, the first execution module 502 is configured to perform at least one of the following:
determining reachability of the terminal, a link state of the terminal, and a location range of the terminal based on a monitoring result of one sequence;
determining reachability of the terminal, a link state of the terminal, and a location range of the terminal based on monitoring results of the plurality of sequences; or
determining reachability of the terminal, a link state of the terminal, and a location range of the terminal based on monitoring results of a preset quantity of sequences.

Optionally, the monitoring result of the terminal meets at least one of the following:
if the monitoring result of the one sequence indicates that the terminal is reachable or that a link is normal, determining that the terminal is reachable or that the link is normal;
if the monitoring results of the plurality of sequences all indicate that the terminal is reachable or that a link is normal, determining that the terminal is reachable or that the link is normal;
if the monitoring results of the preset quantity of sequences indicate that the terminal is reachable or that a link is normal, determining that the terminal is reachable or that the link is normal;
if the monitoring result of the one sequence indicates that the terminal is unreachable or that a link is abnormal, determining that the terminal is unreachable or that the link is abnormal;
if the monitoring results of the plurality of sequences all indicate that the terminal is unreachable or that a link is abnormal, determining that the terminal is unreachable or that the link is abnormal;
if the monitoring results of the preset quantity of sequences indicate that the terminal is unreachable or that a link is abnormal, determining that the terminal is unreachable or that the link is abnormal;
if the monitoring result of the one sequence indicates that the terminal does not move out of the location range or has no location update, determining that the terminal does not move out of the location range or has no location update;
if the monitoring results of the plurality of sequences all indicate that the terminal does not move out of the location range or has no location update, determining that the terminal does not move out of the location range or has no location update;
if the monitoring results of the preset quantity of sequences indicate that the terminal is not out of the location range or has no location update, determining that the terminal is not out of the location range or has no location update;
if the monitoring result of the one sequence indicates that the terminal moves out of the location range or has a location update, determining that the terminal moves out of the location range or has the location update;
if the monitoring results of the plurality of sequences all indicate that the terminal moves out of the location range or has a location update, determining that the terminal moves out of the location range or has the location update; or
if the monitoring results of the preset quantity of sequences indicate that the terminal moves out of the location range or has a location update, determining that the terminal moves out of the location range or has the location update.

Optionally, the first execution module 502 is configured to:

in a case that a plurality of sequences of the beacon signal are detected, determine, based on a measurement result of at least one sequence, whether to perform a measurement-associated behavior.

Optionally, the at least one sequence includes a plurality of sequences, and the determining, based on measurement results of the plurality of sequences, whether to perform a measurement-associated behavior includes at least one of:
determining, based on a combined value of the measurement results of the plurality of sequences, whether to perform the measurement-associated behavior;
determining, based on a measurement result of each of the plurality of sequences, whether to perform the measurement-associated behavior; or
determining, based on measurement results of a preset quantity of sequences among the plurality of sequences, whether to perform the measurement-associated behavior.

Optionally, the at least one sequence includes a plurality of sequences, and the determining, based on measurement results of the plurality of sequences, whether to perform a measurement-associated behavior includes at least one of the following:
if a measurement result of one of the plurality of sequences meets a measurement condition, determining to perform the measurement-associated behavior;
if the measurement results of the plurality of sequences all meet a measurement condition, determining to perform the measurement-associated behavior;
if measurement results of a preset quantity of sequences among the plurality of sequences meet a measurement condition, determining to perform the measurement-associated behavior;
if a measurement result of one of the plurality of sequences does not meet a measurement condition, determining not to perform the measurement-associated behavior;
if a measurement result of none of the plurality of sequences meets a measurement condition, determining not to perform the measurement-associated behavior; or
if measurement results of a preset quantity of sequences among the plurality of sequences do not meet a measurement condition, determining not to perform the measurement-associated behavior.

Optionally, the measurement-associated behavior includes at least one of the following:
cell selection, cell reselection, serving cell measurement, neighboring cell measurement, measurement reporting, measurement relaxation, measurement enhancement, or whether to enable the measurement.

Optionally, in a case that the terminal is capable of receiving at least one sequence of the beacon signal, the terminal is reachable, a link is normal, or the terminal is capable of receiving a low power wake-up signal LP-WUS; or in a case that the terminal is capable of receiving a target sequence of the beacon signal, the terminal is reachable, a link is normal, or the terminal is capable of receiving an LP-WUS; and/or
in a case that the terminal is incapable of receiving at least one sequence of the beacon signal, the terminal is unreachable, a link is abnormal, or the terminal is incapable of receiving an LP-WUS; or in a case that the terminal is incapable of receiving a target sequence of the beacon signal, the terminal is unreachable, a link is abnormal, or the terminal is incapable of receiving an LP-WUS.

Optionally, that the terminal is incapable of receiving an LP-WUS includes at least one of the following:
the terminal is incapable of receiving an LP-WUS signal corresponding to a current cell; or
the terminal is incapable of receiving an LP-WUS signal corresponding to one or more sequences or a preset sequence of the beacon signal.

Optionally, the apparatus further includes a second execution module, where the second execution module is configured to perform at least one of the following:
in a case that it is determined that the terminal is reachable, or that a link is normal, or that the terminal is capable of receiving an LP-WUS, monitoring a wake-up signal;
in a case that it is determined that the terminal is reachable, or that a link is normal, or that the terminal is capable of receiving an LP-WUS, remaining in the sleep state;
in a case that it is determined that the terminal is unreachable or that a link is abnormal, awakening or enabling a main receiver or a main receiving module;
in a case that it is determined that the terminal is unreachable, or that a link is abnormal, or that the terminal is incapable of receiving an LP-WUS, receiving system information;
in a case that it is determined that the terminal is unreachable, or that a link is abnormal, or that the terminal is incapable of receiving an LP-WUS, performing a tracking area update;
in a case that it is determined that the terminal is unreachable, or that a link is abnormal, or that the terminal is incapable of receiving an LP-WUS, performing cell selection or reselection;
in a case that it is determined that the terminal is unreachable, or that a link is abnormal, or that the terminal is incapable of receiving an LP-WUS, performing PLMN selection or reselection;
in a case that it is determined that the terminal is unreachable, or that a link is abnormal, or that the terminal is incapable of receiving an LP-WUS, entering an idle state or an inactive state;
in a case that it is determined that the terminal is unreachable, or that a link is abnormal, or that the terminal is incapable of receiving an LP-WUS, deactivating or disabling a low power wake-up function;
in a case that it is determined that the terminal is unreachable, or that a link is abnormal, or that the terminal is incapable of receiving an LP-WUS, exiting the sleep state; or
in a case that it is determined that the terminal is unreachable, or that a link is abnormal, or that the terminal is incapable of receiving an LP-WUS, skipping or ignoring a wake-up signal.

Optionally, in a case that at least one sequence of the beacon signal that the terminal is capable of receiving corresponds to a current cell of the terminal, it is determined that the terminal is not out of a location range or has no location update; and/or
in a case that the terminal is incapable of receiving at least one sequence of the beacon signal corresponding to a current cell of the terminal, it is determined that the terminal moves out of a location range or has a location update; or in a case that the terminal is incapable of receiving a target sequence of the beacon signal, it is determined that the terminal moves out of a location range or has a location update.

Optionally, the apparatus further includes a third execution module, where the third execution module is configured to perform at least one of the following:
in a case that the terminal does not move out of a location range or has no location update, determining that the terminal is within a range of a current cell;
in a case that the terminal does not move out of a location range or has no location update, monitoring a wake-up signal;
in a case that the terminal does not move out of a location range or has no location update, remaining in the sleep state;
in a case that the terminal moves out of a location range or has a location update, determining that the terminal is not within a range of a current cell;
in a case that the terminal moves out of a location range or has a location update, determining that the terminal is unreachable or incapable of receiving an LP-WUS;
in a case that the terminal moves out of a location range or has a location update, awakening or enabling a main receiver or a main receiving module;
in a case that the terminal moves out of a location range or has a location update, receiving system information;
in a case that the terminal moves out of a location range or has a location update, performing a tracking area update;
in a case that the terminal moves out of a location range or has a location update, performing cell selection or reselection;
in a case that the terminal moves out of a location range or has a location update, performing PLMN selection or reselection;
in a case that the terminal moves out of a location range or has a location update, entering an idle state or an inactive state;
in a case that the terminal moves out of a location range or has a location update, deactivating or disabling a low power wake-up function;
in a case that the terminal moves out of a location range or has a location update, exiting the sleep state; or
in a case that the terminal moves out of a location range or has a location update, skipping or ignoring a wake-up signal.

Optionally, that the terminal is incapable of receiving an LP-WUS includes at least one of the following:
the terminal is incapable of receiving an LP-WUS signal corresponding to the current cell; or
the terminal is incapable of receiving an LP-WUS signal corresponding to one or more sequences or a preset sequence of the beacon signal.

Optionally, the apparatus further includes:
a first receiving module, configured to receive indication information sent by a network side; and
the first execution module 502 is configured to:
perform, by the terminal, the operation based on the indication information and the detection result.

Optionally, the indication information is used to explicitly configure the terminal to perform the operation based on the detection result; and/or
the indication information is used to instruct the terminal to enable a function of performing the operation based on the detection result; and/or
the indication information is used to configure sequences of a plurality of beacon signals, to instruct the terminal to perform the operation based on a detection result of a beacon signal among the plurality of beacon signals; and/or
the indication information is used to configure a target sequence of the beacon signal corresponding to the terminal, to instruct the terminal to perform the operation based on a detection result of the target sequence of the beacon signal.

Optionally, the apparatus further includes:
a second receiving module, configured to receive configuration information sent by a network side, where the configuration information is used to configure at least one of the following:
a correspondence between the beacon signal and a cell;
a correspondence between the beacon signal and a PLMN;
a correspondence between the beacon signal and an area; or
a configuration of the beacon signal.

The signal processing apparatus can improve communication performance of the terminal.

The signal processing apparatus in this embodiment of this application may be an electronic device, for example, an electronic device with an operating system, or may be a component in an electronic device, for example, an integrated circuit or a chip. For example, the electronic device may be a terminal, or may be other devices than a terminal. For example, the terminal may include but is not limited to the illustrated type of the terminal in the embodiment of this application. The other devices may be a server, a network attached storage (Network Attached Storage, NAS), and the like. This is not specifically limited in this embodiment of this application.

The signal processing apparatus provided in this embodiment of this application can implement each process implemented in the method embodiment in FIG. 4, with the same technical effect achieved. To avoid repetition, details are not described herein again.

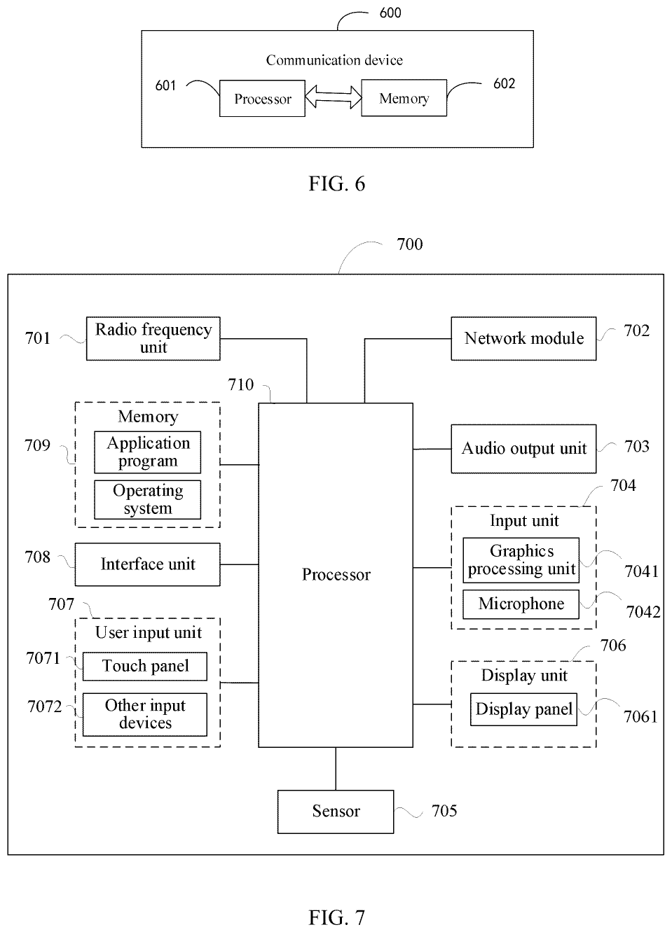

Optionally, as shown in FIG. 6, an embodiment of this application further provides a communication device 600, including a processor 601 and a memory 602, where the memory 602 stores a program or instructions capable of running on the processor 601. For example, when the communication device 600 is a terminal, and the program or instructions are executed by the processor 601, the steps of the foregoing embodiment of the signal processing method are implemented, with the same technical effect achieved. To avoid repetition, details are not described herein again.

An embodiment of this application further provides a communication device, including a processor and a communication interface. The communication interface is configured to detect a beacon signal. The processor is configured to perform an operation based on a detection result of the beacon signal, where the operation includes at least one of the following: reachability monitoring, mobility monitoring, location monitoring, measurement, or link monitoring in a sleep state. The communication device embodiment corresponds to the foregoing embodiment of the measurement information feedback method, and each implementation process and implementation of the foregoing method embodiment can be applied to the communication device embodiment, with the same technical effect achieved.

Specifically, FIG. 7 is a schematic diagram of a hardware structure of a terminal for implementing an embodiment of this application.

The terminal 700 includes but is not limited to at least some components such as a radio frequency unit 701, a network module 702, an audio output unit 703, an input unit 704, a sensor 705, a display unit 706, a user input unit 707, an interface unit 708, a memory 709, or a processor 710.

A person skilled in the art may understand that the terminal 700 may further include a power supply (for example, a battery) supplying power to all components. The power supply may be logically connected to the processor 710 through a power management system. In this way, functions such as charge management, discharge management, and power consumption management are implemented by using the power management system. The terminal structure shown in FIG. 7 does not constitute a limitation on the terminal. The terminal may include more or fewer components than those shown in the figure, or some components are combined, or component arrangements are different. Details are not described herein again.

It should be understood that, in this embodiment of this application, the input unit 704 may include a graphics processing unit (Graphics Processing Unit, GPU) 7041 and a microphone 7042. The graphics processing unit 7041 processes image data of a still picture or video obtained by an image capture apparatus (such as a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 or other input devices 7072. The touch panel 7071 is also referred to as a touchscreen. The touch panel 7071 may include two parts: a touch detection apparatus and a touch controller. The other input devices 7072 may include but are not limited to a physical keyboard, a function button (such as a volume control button or a power button), a trackball, a mouse, and a joystick. Details are not described herein again.

In this embodiment of this application, after receiving downlink data from a network-side device, the radio frequency unit 701 may transmit the downlink data to the processor 710 for processing. In addition, the radio frequency unit 701 may send uplink data to the network-side device. Usually, the radio frequency unit 701 includes but is not limited to an antenna, an amplifier, a transceiver, a coupler, a low noise amplifier, a duplexer, and the like.

The memory 709 may be configured to store software programs or instructions and various data. The memory 709 may primarily include a first storage area for storing programs or instructions and a second storage area for storing data. The first storage area may store an operating system, an application program or instructions required by at least one function (such as an audio play function and an image play function), and the like. In addition, the memory 709 may include a volatile memory or a non-volatile memory, or the memory 709 may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synch Link DRAM, SLDRAM), and a direct rambus random access memory (Direct Rambus RAM, DRRAM). The memory 709 in this embodiment of this application includes but is not limited to these and any other suitable types of memories.

The processor 710 may include one or more processing units. Optionally, the processor 710 integrates an application processor and a modem processor. The application processor mainly processes operations related to the operating system, a user interface, an application program, and the like. The modem processor mainly processes a wireless communication signal. For example, the modem processor is a baseband processor. It may be understood that the modem processor may alternatively be not integrated in the processor 710.

The radio frequency unit 701 is configured to detect a beacon signal.

The processor 710 is configured to perform an operation based on a detection result of the beacon signal, where the operation includes at least one of the following:
reachability monitoring, mobility monitoring, location monitoring, measurement, or link monitoring in a sleep state.

Optionally, the performing an operation based on a detection result of the beacon signal includes at least one of the following:
in a case that one sequence of the beacon signal is detected, performing the operation based on the one sequence; or
in a case that a plurality of sequences of the beacon signal are detected, performing the operation based on a target sequence among the plurality of sequences, where the target sequence is one or more of the plurality of sequences.

Optionally, the target sequence includes at least one of the following:
a sequence whose signal reception quality meets a preset condition among the plurality of sequences;
a sequence corresponding to the terminal among the plurality of sequences; or
a sequence indicated by a network.

Optionally, the sequence whose signal reception quality meets the preset condition among the plurality of sequences includes at least one of the following:
a sequence with best signal reception quality among the plurality of sequences, or a preset quantity of sequences with best signal reception quality among the plurality of sequences; or
a sequence with signal reception quality higher than or equal to a preset threshold among the plurality of sequences, or N sequences with signal reception quality higher than or equal to a preset threshold among the plurality of sequences, where N is a positive integer not exceeding a preset quantity value; and/or
the sequence corresponding to the terminal among the plurality of sequences includes at least one of the following:
a sequence corresponding to a cell, a public land mobile network PLMN, or an area corresponding to the terminal among the plurality of sequences;
a sequence associated with the terminal among the plurality of sequences; or
a sequence corresponding to a group to which the terminal belongs among the plurality of sequences.

Optionally, the cell, the PLMN, or the area corresponding to the terminal includes at least one of the following:
a cell, a PLMN, or an area on which the terminal camps;
a cell, a PLMN, or an area stored by the terminal;
a cell, a PLMN, or an area in which the terminal is located when the terminal enters a low power LP-sleep state;
a cell, a PLMN, or an area in which the terminal is located before the terminal enters the LP-sleep state; or
a cell, a PLMN, or an area configured by the network for the terminal.

Optionally, the performing an operation based on a detection result of the beacon signal includes:
in a case that a plurality of sequences of the beacon signal are detected, determining a monitoring result of the terminal based on a monitoring result of at least one sequence.

Optionally, the determining a monitoring result of the terminal based on a monitoring result of at least one sequence includes at least one of the following:
determining reachability of the terminal, a link state of the terminal, and a location range of the terminal based on a monitoring result of one sequence;
determining reachability of the terminal, a link state of the terminal, and a location range of the terminal based on monitoring results of the plurality of sequences; or
determining reachability of the terminal, a link state of the terminal, and a location range of the terminal based on monitoring results of a preset quantity of sequences.

Optionally, the monitoring result of the terminal meets at least one of the following:
if the monitoring result of the one sequence indicates that the terminal is reachable or that a link is normal, determining that the terminal is reachable or that the link is normal;
if the monitoring results of the plurality of sequences all indicate that the terminal is reachable or that a link is normal, determining that the terminal is reachable or that the link is normal;
if the monitoring results of the preset quantity of sequences indicate that the terminal is reachable or that a link is normal, determining that the terminal is reachable or that the link is normal;
if the monitoring result of the one sequence indicates that the terminal is unreachable or that a link is abnormal, determining that the terminal is unreachable or that the link is abnormal;
if the monitoring results of the plurality of sequences all indicate that the terminal is unreachable or that a link is abnormal, determining that the terminal is unreachable or that the link is abnormal;
if the monitoring results of the preset quantity of sequences indicate that the terminal is unreachable or that a link is abnormal, determining that the terminal is unreachable or that the link is abnormal;
if the monitoring result of the one sequence indicates that the terminal does not move out of the location range or has no location update, determining that the terminal does not move out of the location range or has no location update;
if the monitoring results of the plurality of sequences all indicate that the terminal does not move out of the location range or has no location update, determining that the terminal does not move out of the location range or has no location update;
if the monitoring results of the preset quantity of sequences indicate that the terminal is not out of the location range or has no location update, determining that the terminal is not out of the location range or has no location update;
if the monitoring result of the one sequence indicates that the terminal moves out of the location range or has a location update, determining that the terminal moves out of the location range or has the location update;
if the monitoring results of the plurality of sequences all indicate that the terminal moves out of the location range or has a location update, determining that the terminal moves out of the location range or has the location update; or
if the monitoring results of the preset quantity of sequences indicate that the terminal moves out of the location range or has a location update, determining that the terminal moves out of the location range or has the location update.

Optionally, the performing an operation based on a detection result of the beacon signal includes:
in a case that a plurality of sequences of the beacon signal are detected, determining, based on a measurement result of at least one sequence, whether to perform a measurement-associated behavior.

Optionally, the at least one sequence includes a plurality of sequences, and the determining, based on measurement results of the plurality of sequences, whether to perform a measurement-associated behavior includes at least one of:
determining, based on a combined value of the measurement results of the plurality of sequences, whether to perform the measurement-associated behavior;
determining, based on a measurement result of each of the plurality of sequences, whether to perform the measurement-associated behavior; or
determining, based on measurement results of a preset quantity of sequences among the plurality of sequences, whether to perform the measurement-associated behavior.

Optionally, the at least one sequence includes a plurality of sequences, and the determining, based on measurement results of the plurality of sequences, whether to perform a measurement-associated behavior includes at least one of the following:
if a measurement result of one of the plurality of sequences meets a measurement condition, determining to perform the measurement-associated behavior;
if the measurement results of the plurality of sequences all meet a measurement condition, determining to perform the measurement-associated behavior;
if measurement results of a preset quantity of sequences among the plurality of sequences meet a measurement condition, determining to perform the measurement-associated behavior;
if a measurement result of one of the plurality of sequences does not meet a measurement condition, determining not to perform the measurement-associated behavior;
if a measurement result of none of the plurality of sequences meets a measurement condition, determining not to perform the measurement-associated behavior; or
if measurement results of a preset quantity of sequences among the plurality of sequences do not meet a measurement condition, determining not to perform the measurement-associated behavior.

Optionally, the measurement-associated behavior includes at least one of the following:
cell selection, cell reselection, serving cell measurement, neighboring cell measurement, measurement reporting, measurement relaxation, measurement enhancement, or whether to enable the measurement.

Optionally, in a case that the terminal is capable of receiving at least one sequence of the beacon signal, the terminal is reachable, a link is normal, or the terminal is capable of receiving a low power wake-up signal LP-WUS; or in a case that the terminal is capable of receiving a target sequence of the beacon signal, the terminal is reachable, a link is normal, or the terminal is capable of receiving an LP-WUS; and/or
in a case that the terminal is incapable of receiving at least one sequence of the beacon signal, the terminal is unreachable, a link is abnormal, or the terminal is incapable of receiving an LP-WUS; or in a case that the terminal is incapable of receiving a target sequence of the beacon signal, the terminal is unreachable, a link is abnormal, or the terminal is incapable of receiving an LP-WUS.

Optionally, that the terminal is incapable of receiving an LP-WUS includes at least one of the following:
the terminal is incapable of receiving an LP-WUS signal corresponding to a current cell; or
the terminal is incapable of receiving an LP-WUS signal corresponding to one or more sequences or a preset sequence of the beacon signal.

Optionally, the method further includes at least one of the following:
in a case that it is determined that the terminal is reachable, or that a link is normal, or that the terminal is capable of receiving an LP-WUS, monitoring a wake-up signal;
in a case that it is determined that the terminal is reachable, or that a link is normal, or that the terminal is capable of receiving an LP-WUS, remaining in the sleep state;
in a case that it is determined that the terminal is unreachable or that a link is abnormal, awakening or enabling a main receiver or a main receiving module;
in a case that it is determined that the terminal is unreachable, or that a link is abnormal, or that the terminal is incapable of receiving an LP-WUS, receiving system information;
in a case that it is determined that the terminal is unreachable, or that a link is abnormal, or that the terminal is incapable of receiving an LP-WUS, performing a tracking area update;
in a case that it is determined that the terminal is unreachable, or that a link is abnormal, or that the terminal is incapable of receiving an LP-WUS, performing cell selection or reselection;
in a case that it is determined that the terminal is unreachable, or that a link is abnormal, or that the terminal is incapable of receiving an LP-WUS, performing PLMN selection or reselection;
in a case that it is determined that the terminal is unreachable, or that a link is abnormal, or that the terminal is incapable of receiving an LP-WUS, entering an idle state or an inactive state;
in a case that it is determined that the terminal is unreachable, or that a link is abnormal, or that the terminal is incapable of receiving an LP-WUS, deactivating or disabling a low power wake-up function;
in a case that it is determined that the terminal is unreachable, or that a link is abnormal, or that the terminal is incapable of receiving an LP-WUS, exiting the sleep state; or
in a case that it is determined that the terminal is unreachable, or that a link is abnormal, or that the terminal is incapable of receiving an LP-WUS, skipping or ignoring a wake-up signal.

Optionally, in a case that at least one sequence of the beacon signal that the terminal is capable of receiving corresponds to a current cell of the terminal, it is determined that the terminal is not out of a location range or has no location update; and/or
in a case that the terminal is incapable of receiving at least one sequence of the beacon signal corresponding to a current cell of the terminal, it is determined that the terminal moves out of a location range or has a location update; or in a case that the terminal is incapable of receiving a target sequence of the beacon signal, it is determined that the terminal moves out of a location range or has a location update.

Optionally, the processor 710 is further configured to perform at least one of the following:
in a case that the terminal does not move out of a location range or has no location update, determining that the terminal is within a range of a current cell;
in a case that the terminal does not move out of a location range or has no location update, monitoring a wake-up signal;
in a case that the terminal does not move out of a location range or has no location update, remaining in the sleep state;
in a case that the terminal moves out of a location range or has a location update, determining that the terminal is not within a range of a current cell;
in a case that the terminal moves out of a location range or has a location update, determining that the terminal is unreachable or incapable of receiving an LP-WUS;
in a case that the terminal moves out of a location range or has a location update, awakening or enabling a main receiver or a main receiving module;
in a case that the terminal moves out of a location range or has a location update, receiving system information;
in a case that the terminal moves out of a location range or has a location update, performing a tracking area update;
in a case that the terminal moves out of a location range or has a location update, performing cell selection or reselection;
in a case that the terminal moves out of a location range or has a location update, performing PLMN selection or reselection;
in a case that the terminal moves out of a location range or has a location update, entering an idle state or an inactive state;
in a case that the terminal moves out of a location range or has a location update, deactivating or disabling a low power wake-up function;
in a case that the terminal moves out of a location range or has a location update, exiting the sleep state; or
in a case that the terminal moves out of a location range or has a location update, skipping or ignoring a wake-up signal.

Optionally, that the terminal is incapable of receiving an LP-WUS includes at least one of the following:
the terminal is incapable of receiving an LP-WUS signal corresponding to the current cell; or
the terminal is incapable of receiving an LP-WUS signal corresponding to one or more sequences or a preset sequence of the beacon signal.

Optionally, the radio frequency unit 701 is further configured to:
receive indication information sent by a network side; and the performing an operation based on a detection result includes:
performing the operation based on the indication information and the detection result.

Optionally, the indication information is used to explicitly configure the terminal to perform the operation based on the detection result; and/or
the indication information is used to instruct the terminal to enable a function of performing the operation based on the detection result; and/or
the indication information is used to configure sequences of a plurality of beacon signals, to instruct the terminal to perform the operation based on a detection result of a beacon signal among the plurality of beacon signals; and/or
the indication information is used to configure a target sequence of the beacon signal corresponding to the terminal, to instruct the terminal to perform the operation based on a detection result of the target sequence of the beacon signal.

Optionally, the radio frequency unit 701 is further configured to:
receive configuration information sent by a network side, where the configuration information is used to configure at least one of the following:
a correspondence between the beacon signal and a cell;
a correspondence between the beacon signal and a PLMN;
a correspondence between the beacon signal and an area; or
a configuration of the beacon signal.

The terminal can improve communication performance of the terminal.

An embodiment of this application further provides a readable storage medium. The readable storage medium stores a program or instructions. When the program or instructions are executed by a processor, the steps of the signal processing method provided in the embodiments of this application are implemented.

The processor is a processor in the terminal in the foregoing embodiment. The readable storage medium includes a computer-readable storage medium, such as a computer read-only memory ROM, a random access memory RAM, a magnetic disk, or an optical disc.

In addition, an embodiment of this application provides a chip. The chip includes a processor and a communication interface. The communication interface is coupled to the processor. The processor is configured to run a program or instructions to implement each process of the foregoing embodiment of the signal processing method, with the same technical effect achieved. To avoid repetition, details are not described herein again.

It should be understood that the chip provided in this embodiment of this application may also be referred to as a system-level chip, a system chip, a chip system, a system-on-chip, or the like.

In addition, an embodiment of this application provides a computer program or program product. The computer program or program product is stored in a storage medium. The computer program or program product is executed by at least one processor to implement each process of the foregoing embodiment of the signal processing method, with the same technical effect achieved. To avoid repetition, details are not described herein again.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

According to the foregoing description of the implementations, a person skilled in the art may clearly understand that the methods in the foregoing embodiments may be implemented by using software in combination with a necessary general hardware platform, and certainly may alternatively be implemented by using hardware. However, in most cases, the former is a preferred implementation. Based on such an understanding, the technical solutions of this application essentially or the part contributing to the related art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. A signal processing method, comprising:
detecting, by a terminal, a beacon signal; and
performing, by the terminal, an operation based on a detection result of the beacon signal, wherein the operation comprises at least one of the following:
reachability monitoring, mobility monitoring, location monitoring,
measurement, or link monitoring in a sleep state.

2. The method according to claim 1, wherein the performing, by the terminal, an operation based on a detection result of the beacon signal comprises at least one of the following:
in a case that one sequence of the beacon signal is detected, performing, by the terminal, the operation based on the one sequence; or
in a case that a plurality of sequences of the beacon signal are detected, performing, by the terminal, the operation based on a target sequence among the plurality of sequences, wherein the target sequence is one or more of the plurality of sequences.

3. The method according to claim 2, wherein the target sequence comprises at least one of the following:
a sequence whose signal reception quality meets a preset condition among the plurality of sequences;
a sequence corresponding to the terminal among the plurality of sequences; or
a sequence indicated by a network.

4. The method according to claim 3, wherein the sequence whose signal reception quality meets the preset condition among the plurality of sequences comprises at least one of the following:
a sequence with best signal reception quality among the plurality of sequences, or a preset quantity of sequences with best signal reception quality among the plurality of sequences; or
a sequence with signal reception quality higher than or equal to a preset threshold among the plurality of sequences, or N sequences with signal reception quality higher than or equal to a preset threshold among the plurality of sequences, wherein N is a positive integer not exceeding a preset quantity value; and/or
the sequence corresponding to the terminal among the plurality of sequences comprises at least one of the following:
a sequence corresponding to a cell, a public land mobile network PLMN, or an area corresponding to the terminal among the plurality of sequences;
a sequence associated with the terminal among the plurality of sequences; or
a sequence corresponding to a group to which the terminal belongs among the plurality of sequences.

5. The method according to claim 4, wherein the cell, the PLMN, or the area corresponding to the terminal comprises at least one of the following:
a cell, a PLMN, or an area on which the terminal camps;
a cell, a PLMN, or an area stored by the terminal;
a cell, a PLMN, or an area in which the terminal is located when the terminal enters a low power LP-sleep state;
a cell, a PLMN, or an area in which the terminal is located before the terminal enters the LP-sleep state; or
a cell, a PLMN, or an area configured by the network for the terminal.

6. The method according to claim 1, wherein the performing, by the terminal, an operation based on a detection result of the beacon signal comprises:
in a case that a plurality of sequences of the beacon signal are detected, determining a monitoring result of the terminal based on a monitoring result of at least one sequence.

7. The method according to claim 6, wherein the determining a monitoring result of the terminal based on a monitoring result of at least one sequence comprises at least one of the following:
determining reachability of the terminal, a link state of the terminal, and a location range of the terminal based on a monitoring result of one sequence;
determining reachability of the terminal, a link state of the terminal, and a location range of the terminal based on monitoring results of the plurality of sequences; or
determining reachability of the terminal, a link state of the terminal, and a location range of the terminal based on monitoring results of a preset quantity of sequences.

8. The method according to claim 7, wherein the monitoring result of the terminal meets at least one of the following:
if the monitoring result of the one sequence indicates that the terminal is reachable or that a link is normal, determining that the terminal is reachable or that the link is normal;
if the monitoring results of the plurality of sequences all indicate that the terminal is reachable or that a link is normal, determining that the terminal is reachable or that the link is normal;
if the monitoring results of the preset quantity of sequences indicate that the terminal is reachable or that a link is normal, determining that the terminal is reachable or that the link is normal;
if the monitoring result of the one sequence indicates that the terminal is unreachable or that a link is abnormal, determining that the terminal is unreachable or that the link is abnormal;
if the monitoring results of the plurality of sequences all indicate that the terminal is unreachable or that a link is abnormal, determining that the terminal is unreachable or that the link is abnormal;
if the monitoring results of the preset quantity of sequences indicate that the terminal is unreachable or that a link is abnormal, determining that the terminal is unreachable or that the link is abnormal;
if the monitoring result of the one sequence indicates that the terminal does not move out of the location range or has no location update, determining that the terminal does not move out of the location range or has no location update;
if the monitoring results of the plurality of sequences all indicate that the terminal does not move out of the location range or has no location update, determining that the terminal does not move out of the location range or has no location update;
if the monitoring results of the preset quantity of sequences indicate that the terminal is not out of the location range or has no location update, determining that the terminal is not out of the location range or has no location update;
if the monitoring result of the one sequence indicates that the terminal moves out of the location range or has a location update, determining that the terminal moves out of the location range or has the location update;
if the monitoring results of the plurality of sequences all indicate that the terminal moves out of the location range or has a location update, determining that the terminal moves out of the location range or has the location update; or
if the monitoring results of the preset quantity of sequences indicate that the terminal moves out of the location range or has a location update, determining that the terminal moves out of the location range or has the location update.

9. The method according to claim 1, wherein the performing, by the terminal, an operation based on a detection result of the beacon signal comprises:
in a case that a plurality of sequences of the beacon signal are detected, determining, based on a measurement result of at least one sequence, whether to perform a measurement-associated behavior.

10. The method according to claim 9, wherein the at least one sequence comprises a plurality of sequences, and the determining, based on measurement results of the plurality of sequences, whether to perform a measurement-associated behavior comprises at least one of:
determining, based on a combined value of the measurement results of the plurality of sequences, whether to perform the measurement-associated behavior;
determining, based on a measurement result of each of the plurality of sequences, whether to perform the measurement-associated behavior; or
determining, based on measurement results of a preset quantity of sequences among the plurality of sequences, whether to perform the measurement-associated behavior; or
wherein the at least one sequence comprises a plurality of sequences, and the determining, based on measurement results of the plurality of sequences, whether to perform a measurement-associated behavior comprises at least one of the following:
if a measurement result of one of the plurality of sequences meets a measurement condition, determining to perform the measurement-associated behavior;
if the measurement results of the plurality of sequences all meet a measurement condition, determining to perform the measurement-associated behavior;
if measurement results of a preset quantity of sequences among the plurality of sequences meet a measurement condition, determining to perform the measurement-associated behavior;
if a measurement result of one of the plurality of sequences does not meet a measurement condition, determining not to perform the measurement-associated behavior;
if a measurement result of none of the plurality of sequences meets a measurement condition, determining not to perform the measurement-associated behavior; or
if measurement results of a preset quantity of sequences among the plurality of sequences do not meet a measurement condition, determining not to perform the measurement-associated behavior.

11. The method according to claim 9, wherein the measurement-associated behavior comprises at least one of the following:
cell selection, cell reselection, serving cell measurement, neighboring cell measurement, measurement reporting, measurement relaxation, measurement enhancement, or whether to enable the measurement.

12. The method according to claim 1, wherein in a case that the terminal is capable of receiving at least one sequence of the beacon signal, the terminal is reachable, or a link is normal, or the terminal is capable of receiving a low power wake-up signal LP-WUS; or in a case that the terminal is capable of receiving a target sequence of the beacon signal, the terminal is reachable, or a link is normal, or the terminal is capable of receiving an LP-WUS; and/or
in a case that the terminal is incapable of receiving at least one sequence of the beacon signal, the terminal is unreachable, or a link is abnormal, or the terminal is incapable of receiving an LP-WUS; or in a case that the terminal is incapable of receiving a target sequence of the beacon signal, the terminal is unreachable, or a link is abnormal, or the terminal is incapable of receiving an LP-WUS.

13. The method according to claim 12, wherein that the terminal is incapable of receiving an LP-WUS comprises at least one of the following:
the terminal is incapable of receiving an LP-WUS signal corresponding to a current cell; or
the terminal is incapable of receiving an LP-WUS signal corresponding to one or more sequences or a preset sequence of the beacon signal.

14. The method according to claim 1, wherein the method further comprises at least one of the following:
in a case that it is determined that the terminal is reachable, or that a link is normal, or that the terminal is capable of receiving an LP-WUS, monitoring a wake-up signal;
in a case that it is determined that the terminal is reachable, or that a link is normal, or that the terminal is capable of receiving an LP-WUS, remaining in the sleep state;
in a case that it is determined that the terminal is unreachable or that a link is abnormal, awakening or enabling a main receiver or a main receiving module;
in a case that it is determined that the terminal is unreachable, or that a link is abnormal, or that the terminal is incapable of receiving an LP-WUS, receiving system information;
in a case that it is determined that the terminal is unreachable, or that a link is abnormal, or that the terminal is incapable of receiving an LP-WUS, performing a tracking area update;
in a case that it is determined that the terminal is unreachable, or that a link is abnormal, or that the terminal is incapable of receiving an LP-WUS, performing cell selection or reselection;
in a case that it is determined that the terminal is unreachable, or that a link is abnormal, or that the terminal is incapable of receiving an LP-WUS, performing PLMN selection or reselection;
in a case that it is determined that the terminal is unreachable, or that a link is abnormal, or that the terminal is incapable of receiving an LP-WUS, entering an idle state or an inactive state;
in a case that it is determined that the terminal is unreachable, or that a link is abnormal, or that the terminal is incapable of receiving an LP-WUS, deactivating or disabling a low power wake-up function;
in a case that it is determined that the terminal is unreachable, or that a link is abnormal, or that the terminal is incapable of receiving an LP-WUS, exiting the sleep state; or
in a case that it is determined that the terminal is unreachable, or that a link is abnormal, or that the terminal is incapable of receiving an LP-WUS, skipping or ignoring a wake-up signal.

15. The method according to claim 1, wherein in a case that at least one sequence of the beacon signal that the terminal is capable of receiving corresponds to a current cell of the terminal, it is determined that the terminal is not out of a location range or has no location update; and/or
in a case that the terminal is incapable of receiving at least one sequence of the beacon signal corresponding to a current cell of the terminal, it is determined that the terminal moves out of a location range or has a location update; or in a case that the terminal is incapable of receiving a target sequence of the beacon signal, it is determined that the terminal moves out of a location range or has a location update.

16. The method according to claim 1, wherein the method further comprises at least one of the following:
in a case that the terminal does not move out of a location range or has no location update, determining that the terminal is within a range of a current cell;
in a case that the terminal does not move out of a location range or has no location update, monitoring a wake-up signal;
in a case that the terminal does not move out of a location range or has no location update, remaining in the sleep state;
in a case that the terminal moves out of a location range or has a location update, determining that the terminal is not within a range of a current cell;
in a case that the terminal moves out of a location range or has a location update, determining that the terminal is unreachable or incapable of receiving an LP-WUS;
in a case that the terminal moves out of a location range or has a location update, awakening or enabling a main receiver or a main receiving module;
in a case that the terminal moves out of a location range or has a location update, receiving system information;
in a case that the terminal moves out of a location range or has a location update, performing a tracking area update;
in a case that the terminal moves out of a location range or has a location update, performing cell selection or reselection;
in a case that the terminal moves out of a location range or has a location update, performing PLMN selection or reselection;
in a case that the terminal moves out of a location range or has a location update, entering an idle state or an inactive state;
in a case that the terminal moves out of a location range or has a location update, deactivating or disabling a low power wake-up function;
in a case that the terminal moves out of a location range or has a location update, exiting the sleep state; or
in a case that the terminal moves out of a location range or has a location update, skipping or ignoring a wake-up signal.

17. The method according to claim 1, wherein the method further comprises:
receiving, by the terminal, indication information sent by a network side; and
the performing, by the terminal, an operation based on the detection result comprises:
performing, by the terminal, the operation based on the indication information and the detection result.

18. The method according to claim 17, wherein the indication information is used to explicitly configure the terminal to perform the operation based on the detection result; and/or
the indication information is used to instruct the terminal to enable a function of performing the operation based on the detection result; and/or
the indication information is used to configure sequences of a plurality of beacon signals, to instruct the terminal to perform the operation based on a detection result of a beacon signal among the plurality of beacon signals; and/or
the indication information is used to configure a target sequence of the beacon signal corresponding to the terminal, to instruct the terminal to perform the operation based on a detection result of the target sequence of the beacon signal.

19. The method according to claim 1, wherein the method further comprises:
receiving, by the terminal, configuration information sent by a network side, wherein the configuration information is used to configure at least one of the following:
a correspondence between the beacon signal and a cell;
a correspondence between the beacon signal and a PLMN;
a correspondence between the beacon signal and an area; or
a configuration of the beacon signal.

20. A terminal, comprising a processor and a memory, wherein the memory stores a program or instructions capable of running on the processor, and when the program or instructions are executed by the processor, a signal processing method is implemented, the method comprising:
detecting a beacon signal; and
performing an operation based on a detection result of the beacon signal, wherein the operation comprises at least one of the following:
reachability monitoring, mobility monitoring, location monitoring, measurement, or link monitoring in a sleep state.
